(19) United States
(12) Patent Application Publication
(10) Pub. No.: US 2009/0042164 A1
(43) Pub. Date: Feb. 12, 2009

(54) Driver tip for engaging and releasing an orthodontic bone screw

(76) Inventors: William C. Machata, Kohler, WI (US); Joseph M. Caruso, Redlands, CA (US)

Correspondence Address: Philip G. Meyers;Philip G. Meyers Law Office, Suite 300, 1009 Long Prairie Road, Flower Mound, TX, 75022, US

(21) Appl. No.: 12/220,673

(22) Filed: Jul. 25, 2008

Related U.S. Application Data
(60) Provisional application No. 60/961,931, filed on Jul. 25, 2007.

(51) Int. Cl. A61C 3/00

(52) U.S. Cl. 433/141

(57) ABSTRACT

An orthodontic driver tip according to the invention is configured for screwing and unscrewing an orthodontic bone screw. Such a driver tip includes an elongated inner rod having an enlarged diameter front tip portion with a frontwardly opening recess, which tip portion comprises at least two frontwardly extending resilient arms which define the frontwardly opening recess between them, and a rear connecting portion by which the driver tip can be removably secured to a handle. A sleeve is mounted on the rod rearwardly of the enlarged diameter front tip portion, the sleeve having a front end of lesser diameter than a maximum diameter of the arms of the tip portion. A locking mechanism releasably secures the sleeve against lengthwise movement along the rod when the sleeve is moved forward to a position wherein the arms are bent into engagement with the head of a bone screw disposed inside the front tip portion.

This application claims priority of U.S. provisional patent application No. 60/961,931, filed Jul. 25, 2007.

### FIELD OF THE INVENTION

The invention relates generally to orthodontics and more particularly to a tool for use in placing and removing small orthodontic bone screws for use in intra-oral orthodontic corrections.

### BACKGROUND OF THE INVENTION

As described in Balfour; et al. U.S. Patent Publication No. 20070122764, May 31, 2007, the contents of which are incorporated herein by reference, bone screws are now available for use for orthodontic anchorage. A bone screw of this type is designed to be inserted with a self-piercing and penetrating tip and self tapping locking threads in a single minimally invasive surgical operation. Once it is rigidly inserted into the host bone, standard orthodontic appliances can be attached to the exposed head of the screw. The orthodontic bone screw does not permanently integrate with the host bone, thereby allowing for removal at the completion of orthodontic treatment. A tool resembling a screwdriver is used to insert and later remove the screw.

The driver tool described in Balfour et al. has a tip end formed with a block shaped as a polygon in end view having side walls, ribs extending from selected side walls of the block and a centrally located cylindrical, tapered projection extending axially beyond the block; the block, ribs and projection sized to fit in the respective polygonal recess, cross grooves and cylindrical bored surface of the orthodontic bone screw. This tip end resembles the head of a Philips screwdriver. The end opposite the tip end is mounted in a driver handle sold by Ace Surgical.

A mechanism is provided to separate the driver tool from a bone screw to which it has been engaged for mounting in the host bone. The mechanism includes a threaded shaft on which the tip end is formed and a push-off driver sleeve having an internal thread is threadedly engaged to the thread on the threaded shaft. Upon rotation, the head of the bone screw to which the tip end is engaged, the push-off driver sleeve upon further rotation exerts a force against the head of the bone screw to move the tip end out of engagement with the bone screw.

Other bone screw drivers for orthodontics have taken the opposite approach to Balfour et al. and provided a socket on the tip that surrounds the head of the bone screw. The tool is essentially a miniature socket wrench. See, for example, the Aarhus System octagonal screwdriver marketed by American Orthodontics.

Neither of these approaches has proven free of problems. Tips resembling a Philips screwdriver release relatively easily when installation of the bone screw is done, but are not as secure as a socket tip, causing the bone screw to be installed off axis. Socket tips hold to the screw axis better, but are more difficult to release from the screw head, and the force needed to release the tip will render the anchorage less secure. Anything that causes the screw to wobble in place presents a problem from the standpoint of providing a secure anchorage. The present invention addresses these drawbacks.

### SUMMARY OF THE INVENTION

An orthodontic driver tip according to the invention is configured for screwing and unscrewing an orthodontic bone screw. Such a driver tip includes an elongated inner rod having an enlarged diameter front tip portion with a frontwardly opening recess, which tip portion comprises at least two frontwardly extending resilient arms which define the frontwardly opening recess between them, and a rear connecting portion by which the driver tip can be removably secured to a handle. A sleeve is mounted on the rod rearwardly of the enlarged diameter front tip portion, the sleeve having a front end of lesser diameter than a maximum diameter of the arms of the tip portion. Suitable means are provided for releasably securing the sleeve against lengthwise movement along the rod when the sleeve is moved forward to a position wherein the arms are bent into engagement with the head of a bone screw disposed inside the front tip portion. One such means is a threaded connection between the sleeve and the rod, as described hereafter. In preferred embodiments the resilient arms are configured to engage the outer periphery of a predetermined type of bone screw head. For this purpose the arms extend forward from a front end portion of the rod and form a front end opening that is cylindrical or otherwise rounded, or polygonal. The arms are spaced from each other in the circumferential direction and this is visible as a set of gaps between the arms. In the case of a polygonal front end opening, each arm forms one side of an imaginary polygon, such as a triangle or hexagon for tips with three or six arms, respectively. In a preferred embodiment inner end portions of the arms extend from a front end of the rod at an angle forming a frustoconical surface, wherein the sleeve slides over and engages the frustoconical outer surface when the sleeve is moved forward to a position wherein the arms are bent into engagement with the head of a bone screw disposed inside the front tip portion.

The invention further relates to an improved bone screw for use with the driver tip according to the invention, and the assembly of the screw and driver tip when in use. The improved bone screw has a dual diameter head wherein a distal end portion has a smaller diameter or maximum width than a mid-portion adjacent to it. The front end opening of the tip fits over the distal end portion and ends of the arms engage flange or step formed by the mid-portion. This engagement prevents over-insertion of the tip and improves the holding power of the tip.

An improved orthodontic bone screw of the invention has a threaded body and a head at one end thereof, which head has a first radial flange proximate a distal end thereof and a second radial flange spaced from the first flange between the first flange and the threaded body. The second flange has a greater diameter than the first flange and presents a stop surface for the resilient arms facing the first flange. These and other aspects of the invention are further described in the detailed description that follows.

### BRIEF DESCRIPTION OF THE DRAWINGS

In the accompanying drawings, wherein like numerals denote like elements:

FIG. 1 is an exploded view of a driver tip according to the invention and a bone screw for use with the driver tip;

FIG. 2 is a side view of the driver tip of FIG. 1 assembled with a handle;

FIG. 3 is an enlarged perspective view of the driver tip of FIG. 1 in secure engagement with the external periphery of the bone screw;

FIG. 4 is the same view as FIG. 3, with the sleeve moved rearwardly so that the arms open enough to allow removal of the screw from the driver tip;

FIG. 5 is the same view as FIG. 4, partially cut away;

FIG. 6 is a side view of another form of rod and driver tip according to the invention;

FIG. 7A is a front end view of the driver tip of FIG. 6;

FIGS. 7B and 7C are front end views of other driver tip shapes according to the invention;

FIG. 8 is a side view, partly in section, of the driver tip of FIG. 7C engaging an improved bone screw according to the invention; and

FIG. 9 is a front view of a tongue and groove attachment system of the invention.

### DETAILED DESCRIPTION

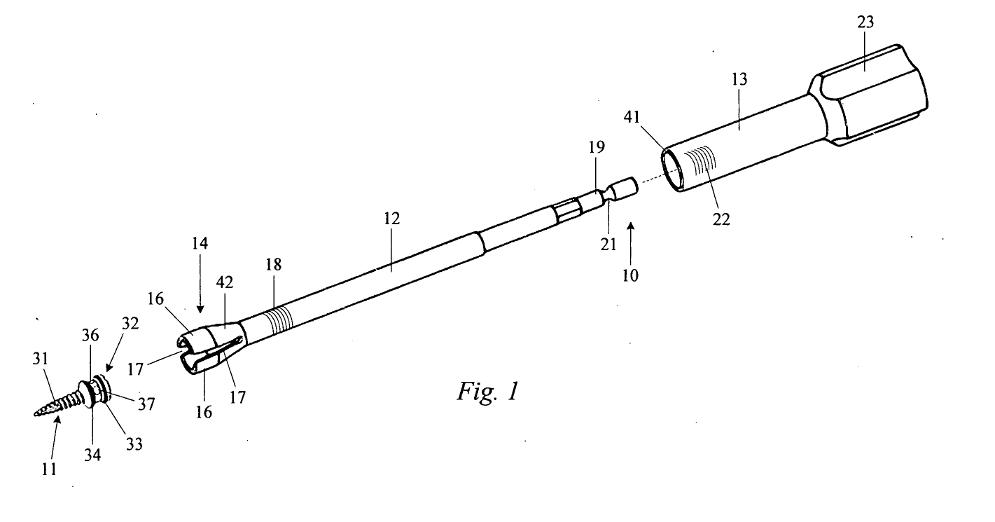

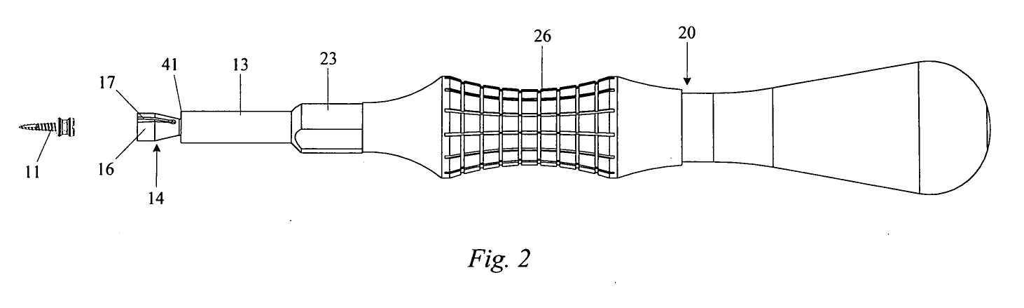

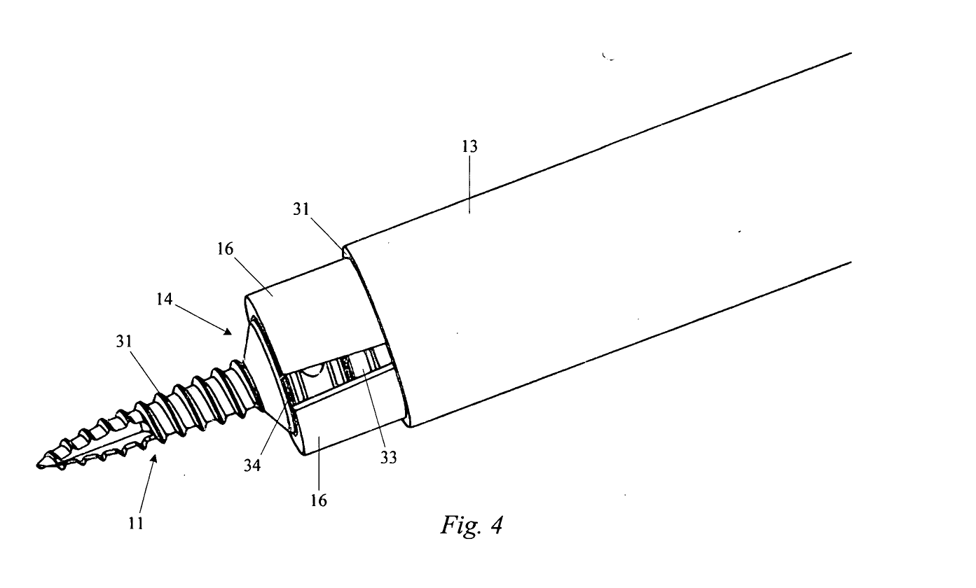

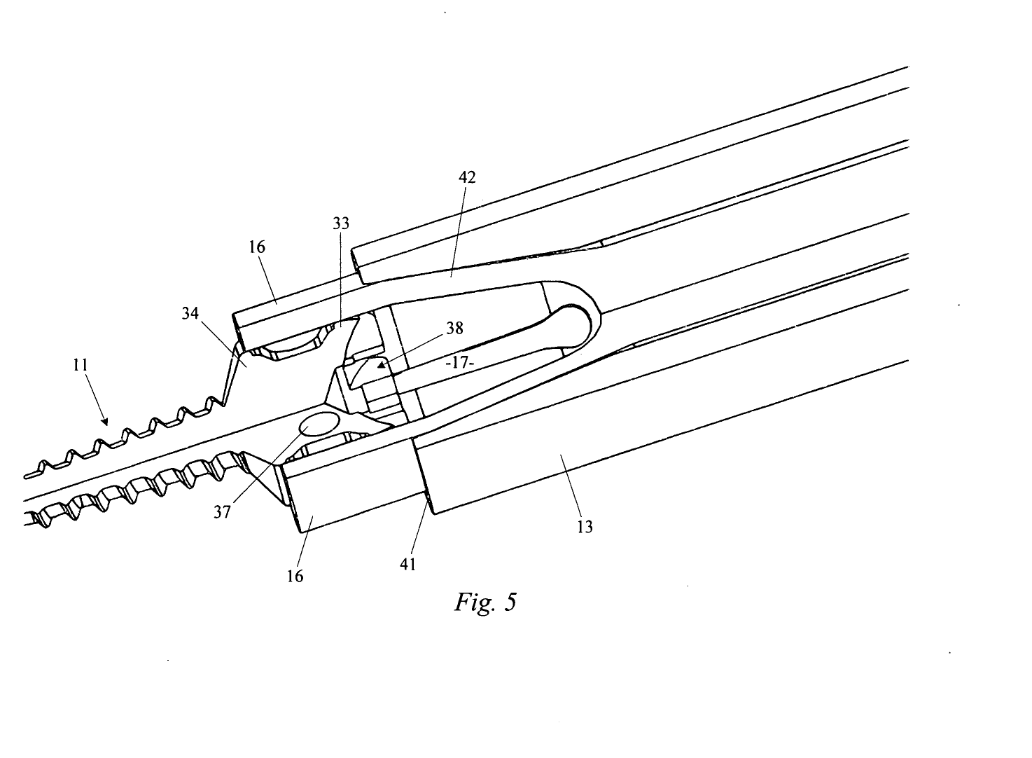

Referring to FIGS. 1-5, an orthodontic driver tip 10 according to the invention suitable for tightening and removing an orthodontic bone screw 11, such as the one described in Balfour et al. cited above, includes an elongated inner rod 12 and a sleeve 13 mounted on the rod 12. A front tip portion 14 of rod 12 has a frontwardly opening cylindrical shape of enlarged diameter compared to the body of rod 12, and comprises a pair of opposed, arcuate resilient arms 16. Two or four arms 16 are formed by a set symmetrically arranged lengthwise cutouts 17 extending rearwardly from the front of tip portion 14. Rod 12 also has external threads 18 formed thereon rearwardly of tip portion 14, and a rear connecting portion 19 that includes an annular groove 21 suitable for engagement with a detent mechanism of a handle 20. Sleeve 13 has internal threads 22 formed therein which can be used to threadedly engage external threads 18 to mount sleeve 13 on rod 12. A rear gripping portion 23 is configured to allow a clinician to thread or unthread sleeve 13.

Prior to use, rear connection portion 19 is inserted into a front socket of handle 20. Handle 20 may be any of a number of known designs wherein the driver tip assembly is inserted and locked in place, then released after use for cleaning. Handle 20 is of the type sold by Ace Surgical as part 454-19501 or -19001 and shown in the Balfour et al. patent application cited above. The user pulls back on a middle barrel section 26 and compresses an internal spring, which makes it possible for the detent such as a metal ball to freely enter and leave annular groove 21. When barrel section 26 is released, the spring then forces the handle mechanism back to the closed position and the detent is locked into groove 21, securing the driver tip 10. In another such handle marketed by Medicon, the barrel section is stainless steel and a sleeve ahead of the barrel section is pulled backward to release the driver tip. These and other similar mechanisms known in the art, such as a chuck for holding a drill bit, could be used to releasably secure the rear end of the driver tip 10 to the handle 20.

Tip portion 14 is configured for precise engagement with orthodontic bone screw 11. Bone screw 11 has a threaded body portion 31 as described in Balfour et al., and a head 32 including a pair of upper and lower annular flanges 33, 34 of like diameter, and a midportion 36 of reduced diameter with transverse holes 37 allowing attachment of orthodontic appliances. A spline drive recess 38 may be provided as part of screw 11, but is not needed in the present invention.

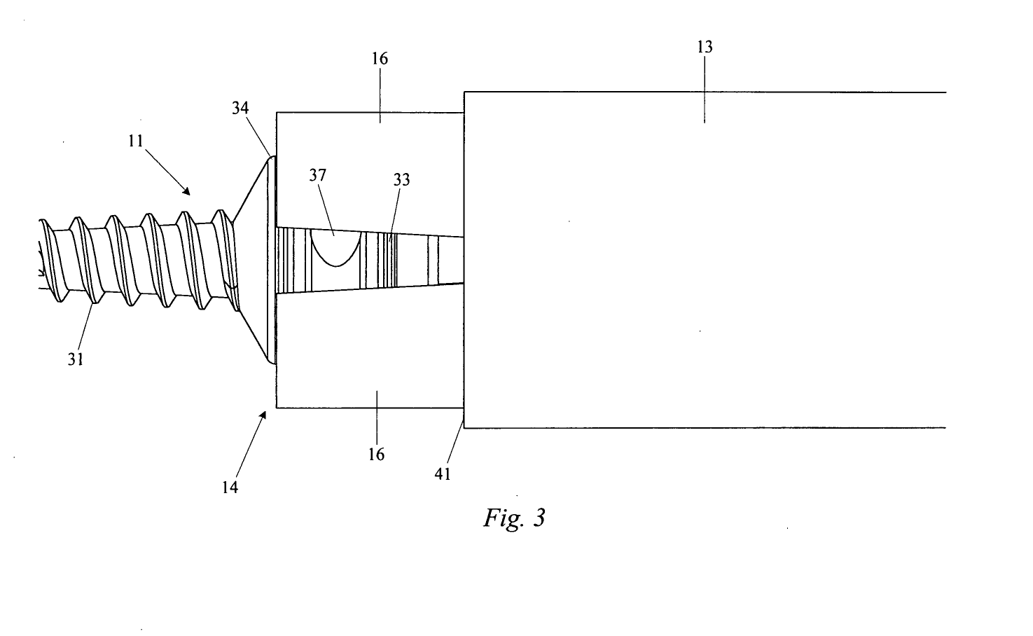

As shown in FIGS. 3-5, tip portion 14 of driver tip 10 is first inserted over head 32. When head 32 is fully inserted, the user can adjust sleeve 13 until its front end 41 engages a rearwardly tapered conical shoulder 42 of tip portion 14. As sleeve 13 continues to move forward by rotation relative to rod 12, tubular end 41 starts to push arms 16 inwardly until they engage annular flanges 33, 34 of screw 11. Once engagement between arms 16 and head 32 is secure, the threaded engagement between sleeve 13 and rod 12 will hold screw 11 in place. The user can then implant screw 11 surgically. When screw 11 is in place, such as in the jaw of a patient, sleeve 13 is unthreaded relative to rod 12 and arms 16 expand and gradually loosen. The user can then safely remove the driver tip 10 from the patient's mouth. The driver tip of the invention thereby achieves the accuracy of the socket-style driver tip, but without the accompanying difficulty in disengaging it from the screw.

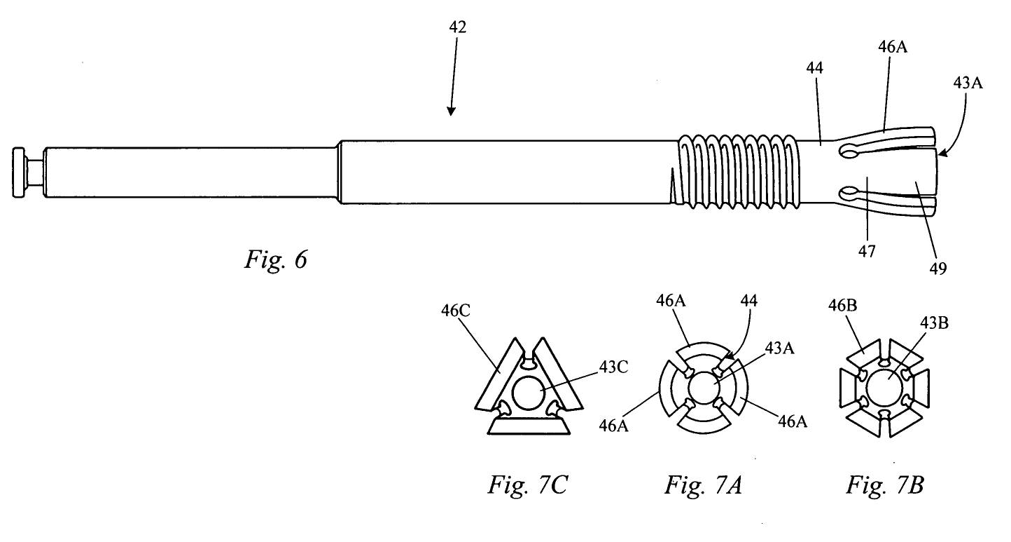

FIGS. 6 and 7A show another embodiment of a rod 42 and tip portion 44 for use in a driver tip according to the invention. This operates in the same manner as rod 12 and tip portion 14 described above. The frontwardly opening recess 43A that engages the head of the screw is cylindrical, but tip portion 44 has four arcuate arms or prongs 46A for engaging the outer periphery of the screw head. FIG. 7A shows the configuration of arms 46A. Arms 46A have first inner portions 47 that angle outwardly (diverge) at an angle preferably in the range of 1 to 45 degrees, especially 5-30°, from the adjacent front end of the rod 42, and then second outer portions 49 that extend straight out from the ends of first portions 47, forming a central bend in each arm 46A. This provides a frontwardly opening recess 43A of the desired diameter and depth for a predetermined size of screw head.

It is known in the art to make bone screw heads that are hexagonal or triangular rather than cylindrical. For this purpose, FIGS. 7B and 7C show a set of six arms 46B and a set of three arms 46C which define recesses 43B, 43C that are hexagonal or triangular, respectively. When the frontwardly opening recess is polygonal as in these examples, then the outer portions of arms 46B, 46C are flat and rectangular as shown, not arcuate.

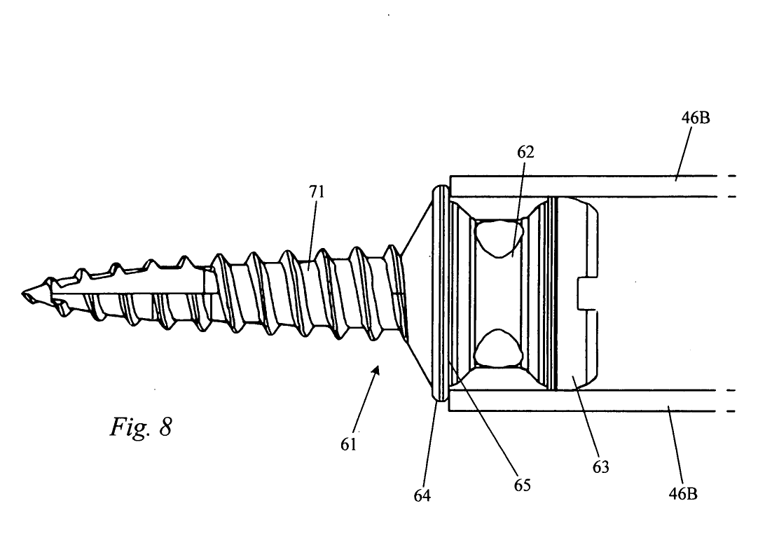

FIG. 8 illustrates the engagement of a modified screw 61 according to the invention with a hexagonal tip as shown in FIG. 7B. Bone screw 61 has a threaded body portion 71 and a head 62 including a pair of upper and lower annular flanges 63, 64. Upper flange 63 has a slightly smaller diameter than lower flange 64. In this manner, arms 46B fit over and engage upper flange 63 and the ends thereof engage a flat annular outer surface 65 of flange 64. This engagement prevents over-insertion of the tip over screw 61 and improves the holding power of the tip, i.e. providing better engagement between the arms and the head of the screw.

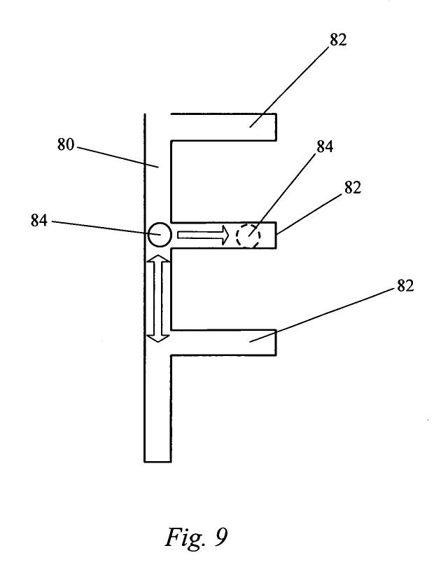

The means for securing the sleeve 13 relative to rod 12 and arms 16 may comprise a tongue and groove mechanism such as shown in FIG. 9 wherein sleeve 13 has a lengthwise groove 80 therein that opens frontwardly. A radial pin 84 provided in place of threads 18 slides into groove 80, which has a number of side branch grooves 82. When the desired tightness is achieved by sliding pin 84 along groove 80, sleeve 13 is twisted circumferentially so that pin 84 enters the nearest branch groove 82 as shown. The user must then twist sleeve 13 in the opposite direction to disassemble the device.

Although the invention has been described with regards to a specific preferred embodiments thereof, variations and modifications will become apparent to those of ordinary skill in the art. It is the intent that the appended claims be interpreted as broadly as possible in view of the prior art as to include all such variations and modifications.

1. An orthodontic driver tip configured for screwing and unscrewing an orthodontic bone screw, comprising:
an elongated inner rod having an enlarged diameter front tip portion with a frontwardly opening recess, which tip portion comprises at least two circumferentially, spaced resilient arms, and a rear connecting portion by which the driver tip can be removably secured to a handle;
a sleeve mounted on the rod rearwardly of the enlarged diameter front tip portion, the sleeve having a front end of lesser diameter than a maximum diameter of the arms of the tip portion; and
a mechanism that releasably secures the sleeve against lengthwise movement along the rod when the sleeve is moved forward to a position wherein the arms are bent into engagement with the head of a bone screw disposed inside the front tip portion.

2. The driver tip of claim 1, wherein the mechanism that releasably secures the sleeve against lengthwise movement along the rod comprises a threaded connection between the inner rod and the sleeve.

3. The driver tip of claim 1, wherein the frontwardly opening recess is cylindrical.

4. The driver tip of claim 1, wherein the frontwardly opening recess is hexagonal.

5. The driver tip of claim 1, wherein the frontwardly opening recess is triangular.

6. The driver tip of claim 1, wherein inner end portions of the arms extend from a front end of the rod at an angle forming a frustoconical surface, wherein the sleeve slides over and engages the frustoconical surface when the sleeve is moved forward to a position wherein the arms are bent into engagement with the head of a bone screw disposed inside the front tip portion.

7. An orthodontic assembly comprising:
an orthodontic bone screw having a threaded body and a head at one end thereof, which head has a first radial flange proximate a distal end thereof and a second radial flange spaced from the first flange between the first flange and the threaded body, which second flange has a greater diameter than the first flange and presents a stop surface facing the first flange; and
an orthodontic driver tool including a handle and a tip configured for screwing and unscrewing an orthodontic bone screw, comprising an elongated inner rod having an enlarged diameter front tip portion with a frontwardly opening recess, which tip portion comprises at least two circumferentially, spaced resilient arms, and a rear connecting portion by which the driver tip can be removably secured to the handle, a sleeve mounted on the rod rearwardly of the enlarged diameter front tip portion, the sleeve having a front end of lesser diameter than a maximum diameter of the arms of the tip portion, and a mechanism that releasably secures the sleeve against lengthwise movement along the rod when the sleeve is moved forward to a position wherein the arms are bent into engagement with the head of the bone screw disposed inside the front tip portion, wherein ends of the arms engage the stop surface of the second flange when the head of the bone screw is fully disposed inside the front tip portion.

8. An orthodontic bone screw having a threaded body and a head at one end thereof, which head has a first radial flange proximate a distal end thereof and a second radial flange spaced from the first flange between the first flange and the threaded body, which second flange has a greater diameter than the first flange and presents a stop surface facing the first flange.
